(19) United States
(12) Patent Application Publication
(10) Pub. No.: US 2005/0060693 A1
(43) Pub. Date: Mar. 17, 2005

(54) Command string parsing

(76) Inventors: Terry Robison, Citrus Heights, CA (US); Thomas Vachuska, Roseville, CA (US); Steven Britt, Roseville, CA (US); Anthony Silva, Antelope, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/648,439

(22) Filed: Aug. 27, 2003

(51) Int. Cl. G06F 9/45

(52) U.S. Cl. 717/143

(57) ABSTRACT

When read by a machine, a computer-readable code arrangement medium causes the machine to parse a command string resulting in the execution of the commands. Such a computer-readable code arrangement includes: a command processor code portion for processing at least one command string having a command-name and at least one parameter; at least one parameter-handler code portion associated with the at least one parameter and adapted for processing the at least one parameter; and at least one syntax store for storing a plurality of syntax descriptions for a set of the command strings and for storing associations between the parameters and the parameter-handler code portions. Such a command processor code portion syntax processes the command string using the syntax descriptions and the parameter-handler code portions.

### BACKGROUND OF THE PRESENT INVENTION

A command-line User Interface (UI) is a basic technique for inputting commands to a computer. While many present-day computing environments are equipped with Graphical User Interfaces (GUIs), the command-line UI (often abbreviated to CLI or CLUI) remains popular, e.g., with experienced users (so-called “power users”) who prefer not to navigate a maze of menus in a GUI to reach a particular command they want to execute.

An attempt has been made in the Background Art to provide a CLI in an object-oriented (OO) environment. In the OO CLI according to the Background Art, different CLI commands are serviced by different action handlers, e.g., classes, which execute corresponding CLI commands. Much of the basic CLI functionality is abstracted away from the action handlers and instead is implemented in a centralized module, class or set of classes, which minimizes command-handler size and redundancy. An action handler fetches its associated command and parameter character strings from a central CLI module running as a “shell”. Then it falls upon the action handler to process the character string parameters, translating them into actionable objects or data structures.

A typical shell parser separates the command parameters supplied through the CLI into separate tokens and then passes those tokens on to a corresponding action handler. For example, when a command like “getActivePrinters -p t100-c” is entered through a typical shell like “sh” or “bash”, the shell can run a action handler taking the form of an executable program-file having the name “getActivePrinters” and pass the parameters like “-p”, “-t100” and “-c” as character strings to the executable program. Here, the shell doesn't understand, nor tries to interpret, nor process parameters like “-p” or “-t100”; that task is left to the executable program. Within a typical OOE CLI, where the action handlers take the form of individual servicing classes or instances of such classes are used (instead of executable programs) to process the tokens of a command, much of the work involved in handling the command is devoted to validating the tokens and creating meaningful, actionable objects or data structures.

In general, a CLI can exhibit pre-processing functionality. Pre-processing of commands should be understood to mean that the command parser of the shell must process, at minimum, at least some parameters of a given command. However, to achieve this, the parser must know the syntax of the commands and also must have a parsing capability that can handle each command. Typically, the syntax of all commands is either hard-coded into the parser or it is required that each new command have its syntax registered with the parser.

### SUMMARY OF THE PRESENT INVENTION

An embodiment of the present invention provides a code arrangement on a computer readable medium that, when read by a machine, causes the machine to parse a command string resulting in the execution of the commands. Such a code arrangement includes: a command processor code portion for processing at least one command string having a command-name and at least one parameter; at least one parameter-handler code portion associated with the at least one parameter and adapted for processing the at least one parameter; and at least one syntax store for storing a plurality of syntax descriptions for a set of the command strings and for storing associations between the parameters and the parameter-handler code portions. Such a command processor code portion syntax processes the command string using the syntax descriptions and the parameter-handler code portions.

Further areas of applicability of the present invention will become apparent from the detailed description provided hereinafter. It should be understood that the detailed description and specific examples are intended for purposes of illustration only and are not intended to limit the scope of the present invention.

### BRIEF DESCRIPTION OF THE DRAWINGS

The present invention will become more fully understood from the detailed description and the accompanying drawings, wherein:

FIG. 1 is a conceptual block diagram of a command-line system according to an embodiment of the present invention;

FIG. 2 describes the main processor according to an embodiment of the present invention;

FIG. 3 is a flowchart according to an embodiment of the present invention;

FIG. 4 is a flowchart for an action handler according to an embodiment of the present invention;

FIG. 5A shows a representation of a syntax package according to an embodiment of the present invention;

FIG. 5B shows a representation of a syntax leaf node according to an embodiment of the present invention;

FIG. 5C shows a representation of a syntax fragment node according to an embodiment of the present invention;

FIG. 5D shows a representation of a syntax root according to an embodiment of the present invention; and

FIGS. 6A and 6B together form a sequence diagram showing the communication of messages between objects according to an embodiment of the present invention.

### DETAILED DESCRIPTION OF EXAMPLE EMBODIMENTS

An embodiment of the present invention, at least in part, is the recognition of the following. The Background Art object-oriented (OO) environment command line interface (CLI) suffers a problem that the “shell” functions as a simple conduit for receiving and passing parameters. The Background Art shell parser does not promote the OO goal of encapsulating data entities in an object format since it passes string parameters, not objects, to action handlers. Hence, there is a need for a CLI shell that promotes OO goals by converting the command-line parameters from character strings to objects before passing those parameters to the action handler, e.g., servicing module or class. There also is a need for a centralized shell mechanism or system in an OO environment that can also perform pre-processing or complete processing of commands to minimize redundancy between action handlers, e.g., servicing classes. Also, the Background Art pre-processing is inflexible and does not maximize abstraction of command handling from the servicing classes. Further, adding a new command so that the parsing shell can interpret the character string associated with it can involve considerable effort, time and cost.

An embodiment of the present invention provides a command-line (command string) processing system for an OO environment. A command processor receives a command-string that is parsed into character string tokens. A parameter-handler (a type of parser) then attempts to match each successive token against command syntax descriptions that are loaded from syntax files. If the first token is matched against the first item of a command, whether that item is defined to be a command keyword or a parameter, then the parameter-handler tries to match the next token against the next item in the command. This iterative matching process continues until no more matching can be performed. If all specified tokens have been matched successfully against the command syntax, then it is thus determined that the syntax is indeed that of the specified command. But if no match is found for one of the tokens, then the command processor continues its attempts to match the command-string with other syntax descriptions. If the entered command-string does not match any syntax description, then an error is indicated and a help message, e.g., proper usage of the attempted command or the command that most closely matched an invalid command, is outputted to the user or external calling module.

In the process of matching character-string tokens to keywords from a syntax description, the specified token should exactly match the keyword expected by the command processor at that position and/or context within the command-string. Matching character-string tokens to parameters (rather than keywords) is typically more complicated. To match a character-string-token to a parameter from a syntax description, the command processor can invoke a parameter-handler for the type of parameter expected in that position and/or context. The syntax description specifies a parameter-handling module (correspondingly, a type of parser module) that can be invoked (by the corresponding parameter-handler) to validate the command-string token(s) corresponding to the parameter, and convert the parameter value from a character string to a corresponding data object.

The set of parameter-handling modules can be extensible so that external modules may be used in conjunction with basic internal modules that are typically delivered with the command processor itself. Irrespective of whether it is attempting to match a keyword or parameter, if the command processor fails to find a match at any position within the specified command-string, then the command-string as a whole is not considered a match for the syntax description being processed by the command processor. If the entered command-string does indeed match one syntax description by providing valid values for all required keywords and parameters, resulting in a set of data objects that correspond to any specified parameters, then the command is considered a match of the syntax description being processed. The command processor can then proceed to invoke a corresponding action handler.

Such a command-line processing system can successfully process new command-strings when syntax descriptions for such new commands are entered in the syntax files. New commands are those that were previously unsupported by the command-line processing system. The parameter-handling modules can be leveraged and reused by syntax descriptions. This can promote object-oriented design goals and substantially separate command-string parsing and processing concerns from the actual code for the command execution. The command execution code receives a set of data objects on which it can operate rather than a set of tokens that it must itself validate and convert to data objects.

Another embodiment of the present invention permits the command string to be syntactically matched by the command processor code portion and all parameter values within the command string to be converted to their corresponding data objects, which can then be further validated, before any action handler code is invoked to actually execute the task that corresponds to the command. In this way the code that executes the task that corresponds to the command needs to deal only with the data objects that were produced from successfully parsing the command string, providing a distinct separation of that code from the non-essential features associated with syntax specification of the command that invoked the task.

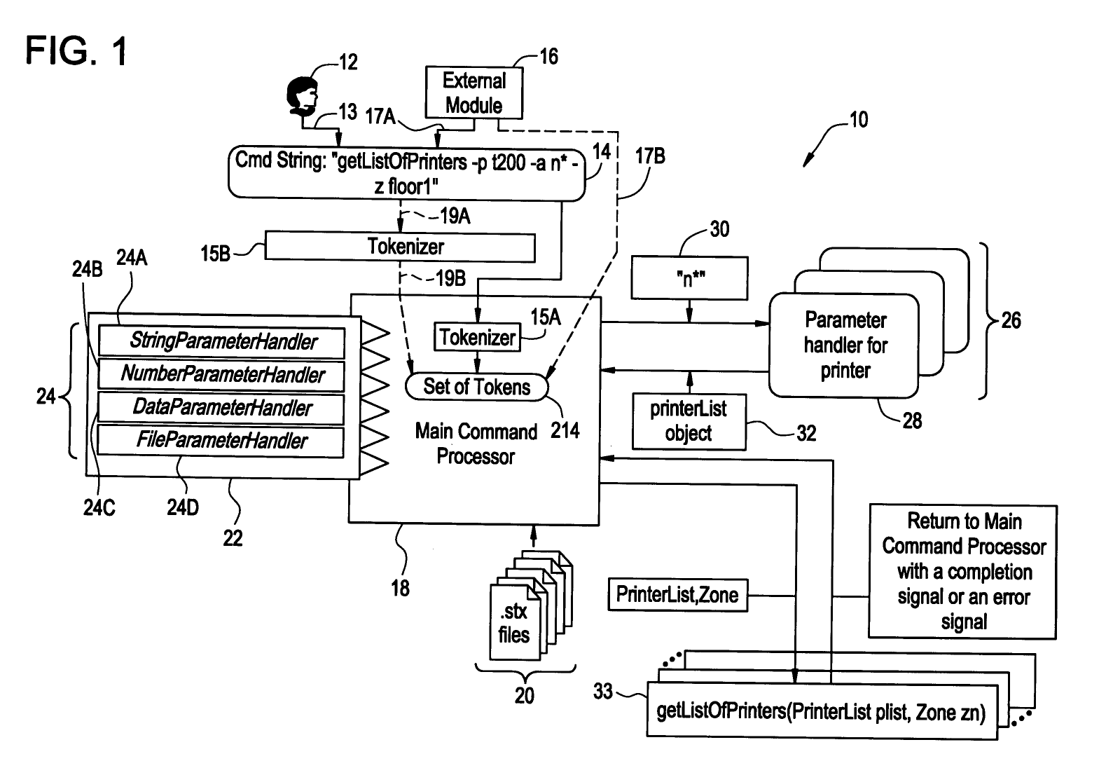

FIG. 1 is a conceptual block diagram of a command-line system 10 according to an embodiment of the present invention. A user 12 can enter a command string 14 through any user terminal (not shown). Alternatively, an external module 16, which can be another program or source of data, can be a source of the command string 14. A main command processor 18 receives the command string 14, which is sourced either through the user 12 (as indicated by path 13) or through the external module 16 (as indicated by path 17A). The system 10 can be software located on a host (not depicted). In the alternative, the system 10 can be implemented as a hardware-only solution or as a solution that combines of hardware and software elements. Those skilled in the art can appreciate that the user 12 and the external module 16 are described as examples of how to supply the command string 14. Alternatives for supplying the command string 14 to the main command processor 18 are not excluded.

In FIG. 1, purely for illustrative purposes, the command string 14 is assumed to be “getListOfPrinters -p t200-a n* -z floor1”. This command string considered is merely an example and is not limiting. This command string may be split into the keyword tokens “getListOfPrinters”, “-p”, “-a”, and “-z” and parameter tokens “t200”, “n*”, and “floor1”. Another way of splitting this string is into syntax fragments; the command name (“getListOfPrinters”) and three fragments that each represent an option for the command where each fragment is composed of a keyword and/or parameter (“-p t200”, “-a n*”, and “-z floor1”).

Keywords, parameters, and even syntax fragments can each be of two types: required (positional) or optional (floating). Required keywords, parameters, and syntax fragments are those that are expected to be at a specific position relative to other required keywords, parameters and syntax fragments within the command string 14 in order for the command string to be correctly matched with the corresponding syntax definition, while optional keywords, parameters, and syntax fragments may appear in any position within the command string or may simply not be specified at all. In the example string above, purely for illustrative purposes, it can be assumed that only the command name keyword, “getListOfPrinters”, is of the required type; the remaining keywords and parameters that compose the syntax fragments for the command options are of the optional type, i.e., their order of occurrence within the string is not relevant.

Main command processor 18 loads syntax files 20, which may contain syntax descriptions for multiple commands. The syntax files 20 may have a distinguishing extension like “.stx” any other extension or no extension at all. The main command processor 18 parses the command string 14 into tokens and iteratively compares such tokens with valid syntax descriptions loaded from the syntax files 20. A valid match occurs if the main command processor 18 can find a previously loaded syntax description that matches the entered command. If no matching syntax description for the entered command is found, then the main command processor 18 outputs an error message describing the syntax description that most closely matched the entered command. The error message can also point out the first incorrectly-matched keyword or parameter and provide correct usage and the expected format of the command, which in the present example might be “getListOfPrinters [-p <password>] [-a <nameFilter>] [-c] [-z<zoneName>]”. Further, the main command processor 18 can output a detailed help message to the user 12 through his or her user terminal to explain how he or she can correct the error in the command input.

Assume an example command string such as “getListOfPrinters -p t200-a n* -z floor1”; this string can represent a command that fetches or displays a list of printers in a networked environment. The “-p t200” represents a password option where “-p” is a keyword and “t200” is the password parameter entered by the user; the password might be used to authenticate whether the user has sufficient permissions to execute the particular command. The “-a” represents a name filter option where “-a” is a keyword and “n*” is a name filter parameter indicating that the user only wants to list active printers that have names starting with the letter ‘n’. The “-z floor1” represents a zone option where “-z” is a keyword and “floor1” is a zone parameter indicating that the user only wants to list printers in the zone called “floor1”. Taken together, the command options indicate that the user only wants to list active printers in zone “floor1” whose names begin with “n”.

The main command processor 18 can include a tokenizing routine (tokenizer) 15A that tokenizes the given command string 14 into a set 214 of string tokens containing or representing the sub-strings: “getListOfPrinters”, “-p”, “t200”, “-a”, “n*”, “-z” and “floor1”. Alternately, the set 214 of string tokens can be prepared/sourced by a tokenizing routine (tokenizer) 15B that is external to the main command processor 18, as indicated by paths 19A and 19B. Further in the alternative, the external module 16 can contain a tokenizer such that the external module 16 can provide/source the set 214 of tokens to the main processor 18, as indicated by path 17B. The first token “getListOfPrinters” is a keyword representing the command name and the other tokens comprise options of the command. If the given set and sequence of tokens matches a syntax description loaded from the syntax files 20, then the command processor 18 proceeds to invoke the action handler 33 specified by the syntax definition that matched the command string 14. The internal workings of the main command processor 18 are described in detail below. Those skilled in the art can appreciate that typically the first token in the command string is a command name followed by zero or more parameters that may be flags, keywords, switches or parameter values. But this arrangement of tokens is not a limitation. Alternative arrangements of tokens can be processed.

Internal parameter-handlers 22 or external parameter-handlers 26 may be used to process the set of tokens 214 that are expected to represent parameters based on the syntax description being matched against. Information about where parameters are expected and the corresponding internal or external parameter-handlers to be used can be stored in the syntax files 20. In the present example, four internal parameter-handlers are shown: “StringParameterHandler” 24A, “NumberParameterHandler” 24B, “DateParameterHandler” 24C and “FileParameterHandler” 24D. Those skilled in the art can appreciate that the internal parameter-handlers 22 shown in FIG. 1 are merely examples and that any number and type of internal parameter-handlers can be included. As briefly discussed above, the term “parameter-handler” is used in a broad sense to include processing elements like parsers, etc.

Considering the present example, the string parser 24A titled as “StringParameterHandler” is an internal parameter-handler that can take a string token as an input and convert it into a string data object. In the present example, the zone name “floor1” is a candidate for parsing by the string parameter-handler 24. The action handler corresponding to the syntax definition for the example should indicate that this parameter should be converted to a string data object. Hence, the main command processor 18 can pass the token “floor1” to the string parameter-handler 24 and the main command processor 18 can receive a string data object in return, which is then placed into the set of data objects that resulted from converting the command parameter arguments.

Additional types of internal parameter-handlers may be included, which can process other types of parameters. For example, the file parameter-handler 24D titled as “FileParameterHandler” could attempt to convert a string token that is expected to specify the full path to a file into a data object containing other data objects that represent constituent components of the filename, like volume/disk name, directory path, and filename. Those skilled in the art will appreciate that separate parameter-handlers, whether internal or external, could also be provided to convert that same string token to a single object holding all such components as member data-items, or even to return a simple string or Boolean data object after validating that the path specified by the token is valid.

Main command processor 18 may also pass command string tokens that cannot be parsed by any internal parameter-handlers 22 to external parameter-handlers 26. Initially, the command processor 18 loads the syntax files 20 and thus becomes configured to recognize which internal and external parameter-handlers exist. After such configuration, the main command processor 18 transparently parses a parameter with either an internal or external parameter-handler as required. The main command processor 18 can invoke both internal and external parameter-handlers in exactly the same manner. An example illustrating the above described parsing follows.

In the present example, main command processor 18 passes the “n*” token, as shown by the input label 30 to the printer parameter-handler 28. The printer parameter-handler 28 can obtain a list of active printers having names that start with the letter ‘n’ using appropriate method/system calls and returns a set of data objects represented by the printerList object 32 to the main command processor 18. The term “method” is used here in a broad sense and can be variously termed as member functions, subroutines, procedures, executable program invocation, etc., depending upon the context.

A parameter-handler may need to consult the set of data objects that have been previously converted from other command string tokens in order to parse the type of parameter with which it is concerned. Using this technique, the main command processor 18 can itself be independent of the syntax definitions that it is attempting to match each command string 14 against. The external parameter-handlers 26 that are invoked when attempting to match a syntax definition should themselves be cognizant of any ties they have to other potentially parsed parameters.

An example described next illustrates the above discussion. In the present illustration, a parameter-handler parses and validates a volume name to ensure that the volume exists and generates a corresponding data object if the specified volume name is valid. In order to perform such validation, the volume parameter-handler would need to know on which host it should check for the volume's existence, necessitating that a host name parameter that produces a host data object be parsed before the volume name parameter. The order in which required parameters are indicated within the syntax definition of a syntax fragment (a command is a form of syntax fragment) allows such specification of parsing order for parameters.

The printer parameter-handler 28 returns a printerList object 32 or a reference to such an object, to main command processor 18. The printerList object 32 can include either a list of names of the appropriate active printers and/or actual data objects that hold detailed information about each appropriate printer. The present printerList example is but a simple illustration. Many real world parameters should be handled with complex and sophisticated algorithms to determine if the parameter is indeed valid, and after which a corresponding set of data objects can be created. The modular design and plug-in ability of the parameter-handlers allows expansion that can encompass new parameters in a reusable way. Only new handlers need to be developed, no changes to the main command processor 18 need be done. Main Command Processor 18 receives data objects from the parameter-handlers and makes the objects available to other handlers that need them.

There may be cases where the Main Command Processor 18 does need to know the results of a parsing operation. For example, the Main Command Processor 18 could have, in its set of external parameter-handler handlers, a parameter-handler that deals with passwords. Main Command Processor 18 can invoke a password parameter-handler (not shown) from among the external parameter-handlers 26, and pass to it the token, e.g., “t200”. Main command processor 18 would then receive from the password parameter-handler a data object that indicates whether sufficient authorization to execute the command is provided by this password or that the password may not be valid. Hence, the main command processor 18 can use external parameter-handlers 26 to process certain parameter types employed in the syntax files 20, while relying on internal parameter-handlers 22 to process other parameter types that are more generally used across a broader scope of commands. Those skilled in the art can appreciate that the user of the system 10 and the action handlers 33 have transparent access to the external and internal parameter-handlers.

Main command processor 18 utilizes both the internal parameter-handlers 22 and external parameter-handlers 26, as stated above, in its attempt to convert the specified command string into a set of data objects that correspond to the parameters of a known command syntax. If the main command processor 18 is successful in matching the command string to a syntax, meaning that all tokens in the command string matched keywords or parameters expected by that syntax, the result is a list of data objects that correspond to the parameters within the command string. After this list has been assembled, the main command processor 18 can invoke the action handler 33 “getListOfPrinters” and pass to it the list of assembled data objects including a printerList object, a string object representing “floor1”, and an authorization object that indicates whether the user has sufficient security privileges to execute the command. The action handler 33 can be configured as a single code arrangement that can execute multiple variations of a single command. Alternately, a separate version of action handler 33 can be provided for each variation of the given command. Those skilled in the art will appreciate that the manner of configuring action handler 33 is does not limit embodiments of the present invention.

The main command processor 18 can process all parameters into objects before calling the action handler 33 which actually executes the task corresponding to the command. The term “objects” can be generally termed as information units, the term “parsing” defined to mean the conversion of string tokens into their corresponding data objects, while “action handler” generally refers to software functions or methods that execute the task represented by a command. Thus, the centralized command parsing separates the parameter parsing logic from the actual action handler logic, leading to better separation of concerns and OO-designs. However the code modules that are used as parameter-handler handlers 26 may contain functionality that does more than convert strings to objects. Those skilled in the art will appreciate that any type of functionality can reside in the parameter-handler code modules 26.

If the action handler 33 successfully processes the list of data objects provided to it, then it returns a completion signal to the main command processor 18. However, the action handler 33 can return an error code or exception if it is unable to execute due to some anomaly in the parameters. In case of an error, the main command processor 18 can provide a centralized mechanism for error reporting and for providing pertinent help messages to the user regarding such errors. In other words, a centralized command processing framework with an OO-type coupling between the centralized command processing and the actual command action handlers is provided.

The degree of parsing provided by the main command processor 18 can be controlled by the syntax specification of a command and the complexity of the task to be carried out by the corresponding action handler 33. However, in most cases, the main command processor 18 can perform almost complete or fully complete parsing of a command's parameters before invoking the action handler 33 that ultimately uses the parameter objects to execute the task that corresponds to the command.

An embodiment of the present invention partitions the command parsing and processing functions, and is object-oriented, e.g., because objects are passed as parameters to the action handlers 33 in place of string tokens (that would subsequently be converted to parameters). For example, the action handler methods for two commands like “getPrinterList” and “getScannerList” may both require a parameter for password validation. Thereafter, the system designer can separate the process of converting and validating the password from each action handler, embody it in a password parameter-handler, and leverage that parameter-handler between the two commands by defining a syntax for each command in the syntax files 20 that uses the parameter-handler to validate the existence and value provided for the command's password. Thus, the main command processor 18 can invoke the same password parameter-handler for both the “getPrinterList” and “getScannerList” commands. Using the conventional approach, both “getPrinterList” and “getScannerList” command action handlers would replicate such password parsing code. Such centralized parsing achieves a well-defined separation of duties between parameter parsing code and command action handler code.

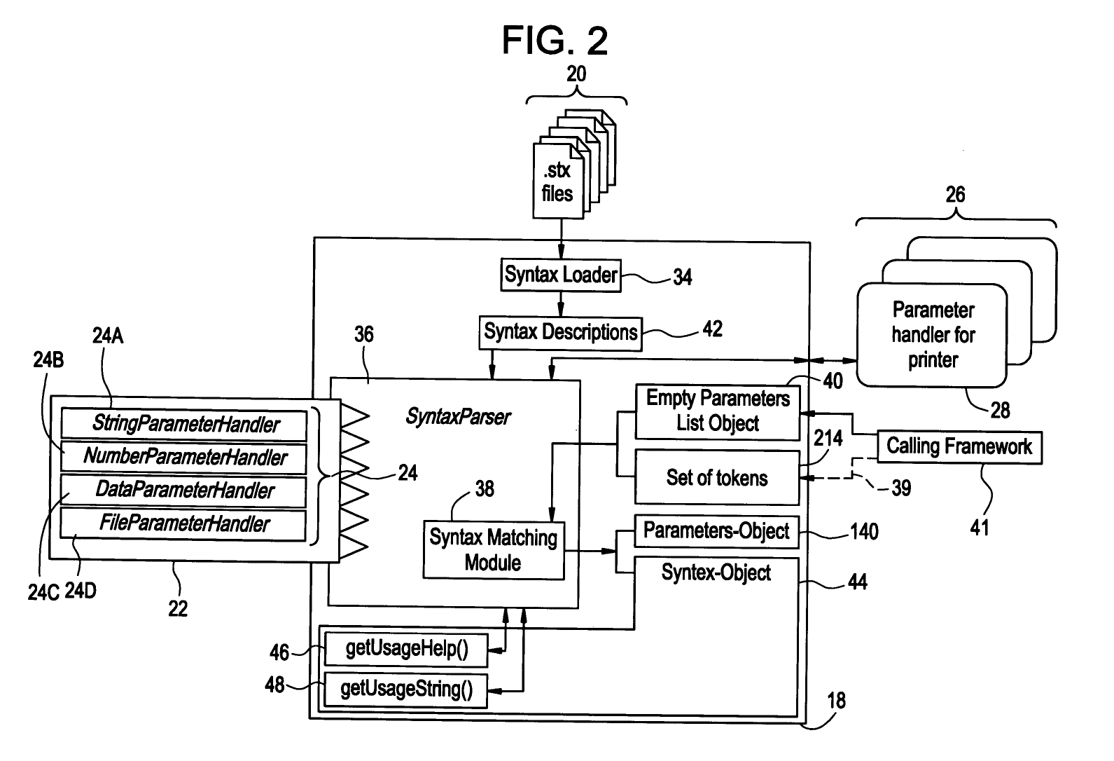

As with the parameter-handlers 26, action handlers 33 can be added in a plug-in fashion. The modular design and plug-in ability of the action handlers allows expansion that can encompass new action handlers in a reusable way. Only new action handlers need to be developed, no changes to the main command processor 18 need be done. Further all existing parameter-handlers 26 are available to new action handlers. Those skilled in the art can appreciate that adding new commands to the system is simplified to a task of creating a new instance of an action handler 33 and making reference to the new instance of the action handler 33 in the syntax files 20; see FIG. 2 and the related discussion below.

FIG. 2 describes the main command processor 18 in further detail according to an embodiment of the present invention. A syntax loader module 34 is part of the main command processor 18. Syntax loader 34 loads command syntax descriptions from the syntax files 20. Though all syntax files 20 would typically have the same file extension, it is not necessary that all such extensions be the same. For example, the extension “.stx” is being used in the examples, but any other distinguishing extension, no extension at all, or combination thereof could be used as well. Syntax files 20 provide an easy and convenient method of defining new CLI commands via syntax descriptions. The main command processor 18 needs no modification when a new command is be added to the system as the new command can be entered via the syntax files 20, either by adding a new syntax file to the set or extending an existing file to include the new syntax description. If certain parameters of the newly-described command require parameters to be handled for which existing internal parameter-handlers do not exist, then new parameter-handlers may be created and registered via the syntax files 20. Hence, the syntax files 20 provide a flexible plug-in-like mechanism for adding new CLI command capability to the system.

In FIG. 2, a module in the main processor 18, named syntax parser 36, orchestrates the parsing tasks. A syntax-matching module 38, which is part of the syntax parser 36 module, initiates the actual syntax matching process. The syntax-matching module 38 receives the set of tokens 214. Again, the set 214 can represent a command string that was tokenized externally and provided to the main command processor 18 (e.g., via an external calling framework 41, as indicated by path 39) or was tokenized internally by the main command processor 18 based upon the provided command string 14. The syntax-matching module 38 also receives an empty parameter list object 40 and a string-to-object mapping 140 initialized by syntax parser 36. The external calling framework 41 can be the external module 16 (shown in FIG. 1) or any other code that can tokenize the command arguments and requires command processing capabilities. Syntax-matching module 38 initiates a comparison process between the token set 214 and the syntax descriptions 42 loaded from the syntax files 20.

The term “syntax descriptions” is used in a broad sense and covers different types of syntax descriptions that are detailed below. If the syntax-matching module 38 finds a successful match between the token set 214 and any one of the syntax descriptions 42, then it implies that all required keywords and parameters in the syntax description have been satisfactorily matched with arguments from the token set 214, and optional keywords and parameters supplied in the token set 214 have also been found to match those designated by the syntax description.

If the syntax-matching module 38 detects a syntax description 42 that matches the command string corresponding to the token set 214, then it can return a syntax object 44 and parameter list object 40 to the syntax parser 36. But if the entered arguments in the token set 214 did not match any of the syntax descriptions 42, then the syntax-matching module 38 can return an error indication to syntax parser 36 which is ultimately propagated to main command processor 18. The main command processor 18 in turn may convey the exception or error condition to the user in an appropriate manner, for example, by displaying an error message on the screen. The syntax parser 36 can compare each known syntax description with the token set 214 and can easily track how deep into the description the token set 214 matched. Therefore, the syntax parser 36 can return an indication of which syntax description 42 was the closest match to the command string corresponding to the token set 214 and why the matching process failed along with the exception or error code.

The syntax parser 36 can issue an exception or error code to main command processor 18 as a result of one or more entered command string arguments corresponding to token set 214 not matching any one of the syntax descriptions 42. The main command processor 18 can in turn indicate an error condition to the user 12. Such indication may be minimal, so as to simply indicate that an error occurred, but the syntax parser 36 is capable of returning information to greatly enrich such error reporting. The syntax description 42 which most closely matched the command string corresponding to the token set 214 can be reported to the main command processor 18, and further, the syntax object 44 that represents that closest matching syntax description also provides functions that indicate the correct usage and format of that closest matching command description to the user 12.

The getUsageHelp() 46 and getUsageString() 48 methods are provided by the Syntax object 44. The main command processor 18 may call the getUsageString() function 48 of the Syntax object to have the syntax object provide a short statement of purpose and formatted usage string for the corresponding command that can be displayed to the user as the usage format of the command. Main command processor 18 may also call the getUsageHelp() function 46 to generate a formatted text explanation of each parameter in the formatted usage string of the command. The information required to formulate the usage string can be created from the actual syntax description of the command itself, while the statement of purpose can be an auxiliary string that may be specified for each syntax description that was originally was provided in the syntax files 20. The syntax parser 36 also can output the usage format (syntax) of the intended command obtained from a call to the getUsageString() module 48. Further extensions to the system can be added to generate an extensible Markup Language (XML) schema of all syntax specifications which may be offered through a web-service or other appropriate content-delivery mechanism.

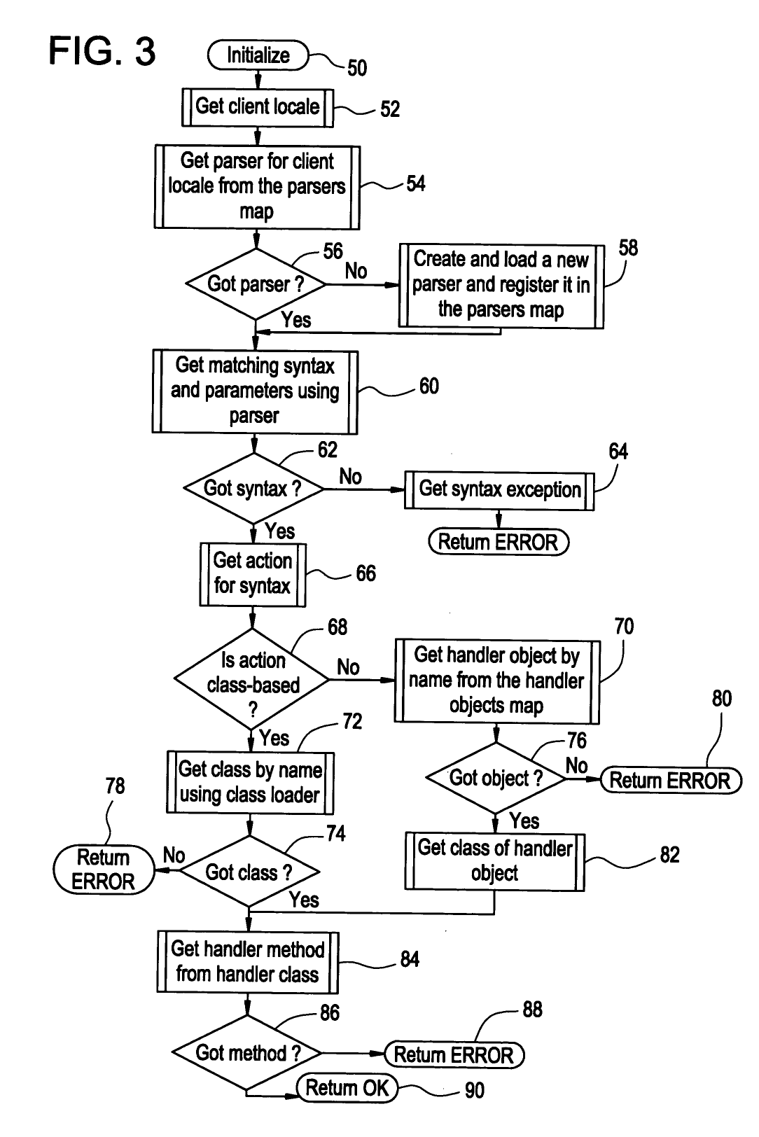

FIG. 3 is a flowchart according to an embodiment of the present invention. The flowchart indicates how the action handler 33 (shown in FIG. 1) is invoked after its name is read from the syntax files 20 (shown in FIG. 1). FIG. 1 corresponds to a single user or single application and is a valid embodiment of the present invention. In contrast, a multi-user embodiment and multi-application embodiment may require additional support elements. For example, in a networked environment running multiple applications, each application may require a certain degree of customization in the operation of syntax parser 36. A typical example of such an implementation/embodiment is described next by reference to FIG. 3.

A command-line UI server (not shown) receives requests from multiple command-line UI clients (not shown) for parsing commands that are either entered by the user 12 (shown in FIG. 1) or sent by the calling framework 41 (shown in FIG. 2). The command-line UI server invokes the main command processor 18 (shown in FIG. 1). At step 50 the main command processor 18 initiates the processing of token set 214. Step 54 indicates that the main command processor retrieves the appropriate syntax parser 36 (shown in FIG. 2) from a map of customized syntax parsers maintained by the command-line UI server. If, at step 56, the system determines that no such customized syntax parser 36 exists for the requesting client, then at step 58 a new parser is created and registered in the parsers map. Hence, the system can make customized syntax parser 36 available to each command-line UI clients as appropriate for that client's requirements.

Once the specific syntax parser 36 is loaded, either by locating it in the parser map at step 56 or creating it at step 58, then the selected syntax parser 36 is used to find a matching syntax description (described above in context of the syntax-matching module 38) as indicated at step 60. At step 62, the main command processor 18 checks to see whether a syntax description 42 (and a corresponding syntax object 44) matching the token set 214 was found. If such a syntax description was not identified, then an exception is returned to the main command processor 18 by the syntax parser 36 at step 64, and the process of generating a descriptive error message as described above is carried out. If a syntax description 42 that matches the token set 214 was found, then the corresponding syntax object 44 is returned to the syntax parser 36.

The embodiment of FIG. 3 can then verify whether the user 12 has a sufficient authorization level to execute the action handler 33 corresponding to the matched syntax object 44. The syntax parser 36 could verify this via a user identifier and password provided as part of the token set 214. The syntax parser 36 could also use information from the syntax object 44 to determine whether a valid license exists for the command represented by that syntax object 44 to execute using an appropriate license checking mechanism and/or code arrangement. In addition to the above described checks, other verifications can also be performed because the appropriate syntax object 44 is available for scrutiny. An exception or error code would be indicated to syntax parser 36 in the same manner discussed earlier, so that it could return this exception or error code back to main command processor 18 which could in turn generate a descriptive error message to the user 12. Alternately, if all provided verification checks are satisfied, then in step 66 the main command processor 18 retrieves the action handler 33 associated with the syntax object 44. The details of how the action handling process is carried out are described next.

In the context of FIG. 3, the main command processor 18 determines the name of the action handler 33 stored in the syntax object 44 that corresponds to the matched syntax description 42. The name of the action handler 33 is preferably stored as a symbolic action name. An embodiment that supports object-oriented languages, for example, could require that the symbolic action name be stored using one of the two following alternative formats:
Format 1: actionName=[class] className:methodName
Format 2: actionName=object objectName:methodName

Format 1 above applies to an action handler 33 that is a static function within a class, while format 2 applies when an action handler 33 is an instance function within a class. Those skilled in the art can appreciate that action handler 33 is an external piece of code and hence the system provides the flexibility of defining it as a class-based static method or as an object-based instance method. The above two ways of defining characteristics of the action handler 33 are by way of illustration only and the same are not limiting. The structure of the syntax files 20 is described in detail later.

In step 68, an embodiment of the main command processor 18 that is designed to support object-oriented action handlers would determine whether the action handler 33 is a class-based static function or an instance function depending upon which of the above formats 1 and 2 are encountered. For the class-based static function format, the main command processor 18 would use an introspection mechanism to acquire a handle to the appropriate method via the provided class name at step 72. For the object-based instance function format, the main command processor 18 would determine whether an object had registered itself with the main command processor using a matching objectName at step 70, and if so the object would be queried to determine its class name in step 82. The introspection mechanism in a typical OOE, e.g. JAVA, may be called reflection or by some other name.

At steps 74 and 76, the main command processor verifies that either the class or object of the action handler 33 as specified by the above formats 1 and 2, respectively, is accessible. If not, then descriptive error messages are returned to the user 12 at steps 78 and 80, respectively. If an object with the specified objectName is registered with the main command processor 18, as determined through searching the object map as shown at step 70, then the class of that handler object is obtained at step 82. Finally, for either the class-based or object-based format of action handler specification, a handle to the actual action handler function 33 is acquired at step 84. At step 86 the main command processor 18 verifies that the action handler function is accessible, and if not generates a descriptive error message to the user 12 at step 88. Otherwise, a handle to the action handler function has been successfully obtained and the process of matching the syntax, converting its parameters to data objects, and acquiring a handler to the action handler finishes at step 90. The next description relates to the main command processor 18 invoking the action handler by passing it the list of data objects that correspond to the parameters specified in token set 214.

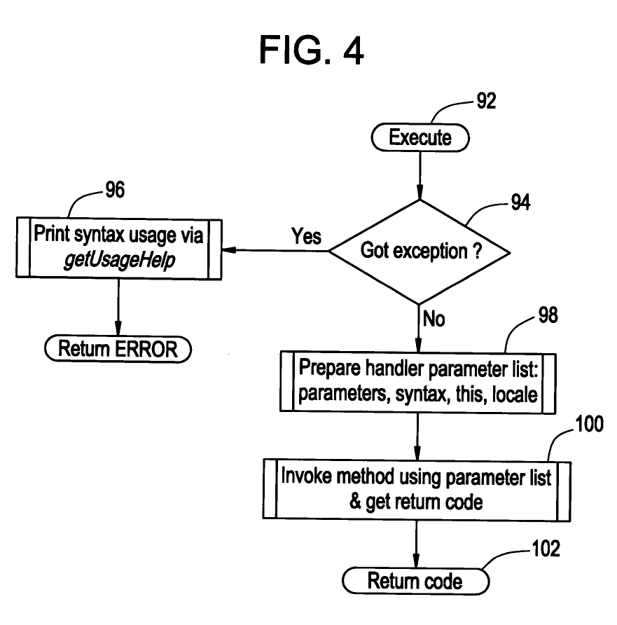

FIG. 4 is a flowchart that illustrates how the main command processor 18 determines whether to execute the action handler 33 according to an embodiment of the present invention. The flowchart begins at step 92. At step 94, the main command processor 18 determines whether an exception or error condition resulted when attempting to match a syntax description 42 with the specified command string 14; or, when verifying that the user 12 was authorized to execute the command, that a valid license exists to permit execution of the command, and so on. If the syntax parser 36 returned such an exception or error code, then the main command processor 18 generates a descriptive error message for display to the user 12 at step 96. If no such exception or error code was returned by the syntax parser 36, then at step 98 the main command processor prepares a parameter list to use when invoking the action handler function 33 and invokes the action handler at step 100. The return code generated by the action handler 33 is processed at step 102, and the appropriate success or error information is generated by the main command processor 18 for display to the user 12.

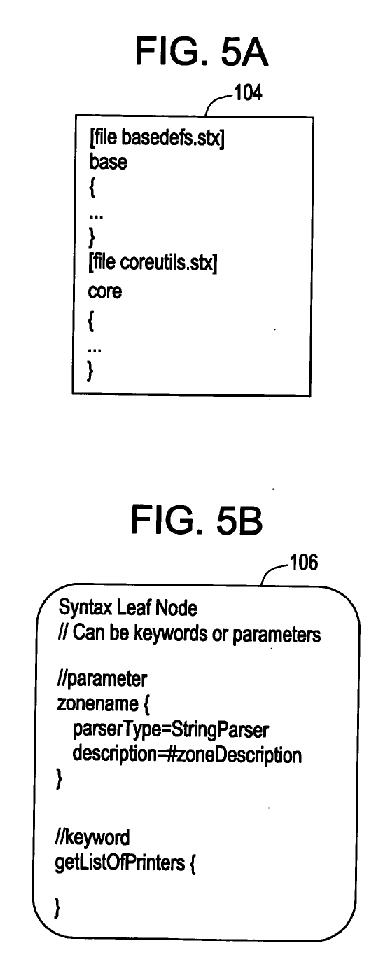

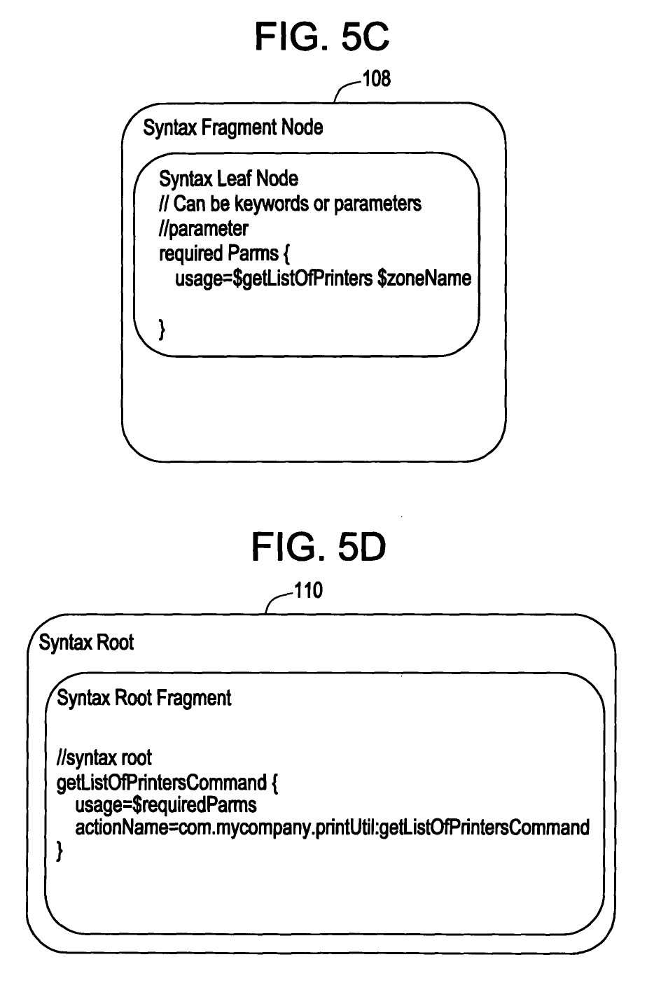

FIGS. 5A-5D show example representations of syntax descriptions according to an embodiment of the present invention. FIG. 5A shows the representation of multiple syntax packages, each in its own file, combining to make a system of packages in 104. The two syntax packages shown in snippet 104 are separate sets of definitions that are contained in two separate top-level files, namely “basedefs.stx” and “coreutils.stx”. Note that a set of definitions contained with a single “.stx” file can equal a syntax package, and each syntax package essentially can represent its own name space with regard to internal syntax nodes. The syntax package name (name space) defined in file “basedefs.stx” is “base”, while the syntax package name defined in file “coreutils.stx” is “core”.

Syntax nodes are of two types, syntax leaf nodes and syntax fragment nodes. FIG. 5B shows the syntax file snippet 106 for some exemplary syntax leaf nodes, which may define either syntax keywords (e.g., “getListOfPrinters” in the lower portion of snippet 106) or syntax parameters (e.g., “zoneName” in the upper portion of snippet 106). FIG. 5C shows the syntax file snippet 108 for a syntax fragment node, which represents a combination of other syntax nodes. Syntax fragments may contain syntax leaf node, other syntax fragment nodes, or both.

FIG. 5D shows the syntax file snippet 110, which illustrates a special type of syntax fragment node called the syntax root. The syntax root is a type of syntax fragment node that, in addition to specifying the other properties that non-root syntax fragments provide, also specifies a symbolic actionName. Every command syntax should define a corresponding syntax root node. Other associated syntax leaf or fragment nodes are typically combined via reference by a root syntax node to produce the command usage, and this is coupled with the symbolic actionName to provide the command's syntax definition. The example syntax nodes in FIG. 5 are given as very simple illustrations of how the syntax files 20 may be structured. Those skilled in the art can appreciate that the various embodiments of the present invention are not limited by any particular structure of the syntax files 20 and the same can be implemented by any suitable structure.

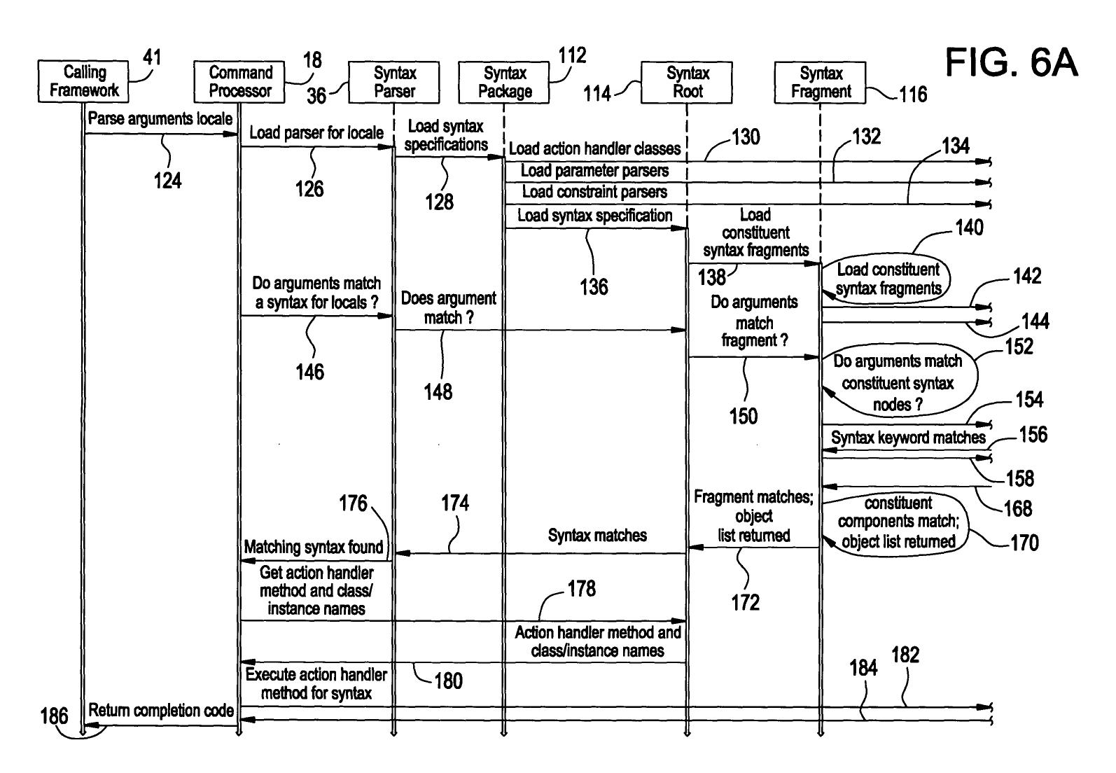

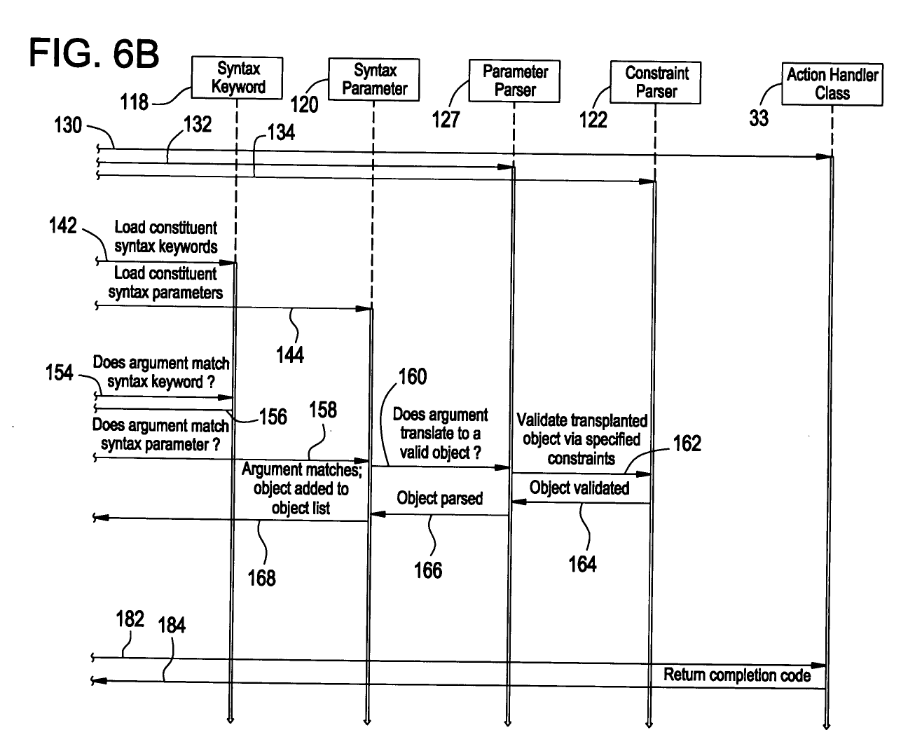

FIGS. 6A and 6B together form a sequence diagram in the style of the Unified Modeling Language (UML) that conveys the interaction between objects according to an embodiment of the present invention. The calling framework 41 passes arguments (comprising token set 214) and client locale information to the main command processor 18 as shown by message 124. The main command processor 18 loads a customized syntax parser 36 which depends upon the client locale, as explained above, as shown by message 126. The syntax parser 36 then loads the syntax definitions from the syntax files 20 (shown in FIGS. 1 and 2) as syntax packages 112 as indicated by message 128. After the syntax descriptions are loaded, the syntax parser 36 proceeds to load all classes, as specified by a portion of the syntax definition (albeit not the portion shown in FIG. 5), that contain action handler functions 33 that are referred to within the syntax file (depicted by message 130). The syntax parser 36 also loads all classes that define external parameter-handlers 26 and constraint parsers 122 as shown by messages 132 and 134, respectively. These classes are again specified by a portion of the syntax definition (albeit, again, not the portion shown in FIG. 5).

As a result of loading each syntax file 20, a new syntax package 112 defining a name space that contains all syntax nodes within that syntax file is created. The syntax package 112 loads the syntax root descriptions, which are each translated into a syntax root 114, shown by message 136. The syntax descriptions of non-root syntax fragments, syntax keywords, and syntax parameters are also loaded and translated into syntax fragment objects 116, keyword objects 118, and syntax parameter objects 120, as shown by messages 138 and 140, 142, and 144 respectively. Since the syntax fragment objects 116 can hold either syntax leaf nodes or other syntax fragments, each syntax fragment object 116 may iteratively load other nested syntax fragments as shown by message 140.

As noted above, syntax fragments may contain syntax leaf nodes, which may be either syntax parameters or syntax keywords. Hence, each syntax fragment object 116 loads each of its constituent syntax keyword objects 118, shown by message 142. Similarly, each syntax fragment object 116 loads each of its constituent syntax parameter objects 120 as shown by message 144. After all syntax definitions have been completely loaded, including root syntax definitions and all constituent non-root syntax fragments and syntax leaf nodes, the system is ready to compare a specified command string 14 with the syntax descriptions from the syntax files 20; these syntax descriptions now are stored in structured class/object arrangements that include objects for the syntax roots 114, syntax fragments 116, syntax keywords 118, and syntax parameters 120.

The syntax matching process in context of FIGS. 6A-6B is discussed next.

The main command processor 18 calls the syntax matching module 38 of the syntax parser 36 as shown by message 146, to determine whether tokens in the set 214 match any known syntax descriptions 42 as represented by the syntax root 114 objects that were loaded given the client locale. The syntax parser 36, in turn, traverses a list of syntax root objects known to be defined for the client locale that is associated with the syntax parser 36 as shown by message 148. As noted above, every command that can be recognized by the system in the specified client locale has one corresponding syntax root object 114 as defined in the syntax files 20. When queried by the syntax parser 36, each syntax root object 114 then checks, as shown by message 150, to see whether the token set 214 matches it. As discussed above in context of FIGS. 5A-D, syntax root is a special type of syntax fragment, so (using object-oriented terminology) message 150 indicates that the syntax root node object invokes a function of its syntax fragment super-class in order to determine if its constituent objects (non-root syntax fragments and syntax leaf nodes) match the token set 214.

There are two classifications of syntax node within a root syntax definition. Beyond the distinction between syntax fragments and syntax leaf nodes, any syntax node may be anchored or floating. An anchored syntax node represents a required argument that should appear in a certain position relative to other required arguments. A floating syntax node represents an optional argument that may or may not appear and does not have to be in any particular order relative to other anchored or floating arguments. Each syntax fragment object 116 examines its constituent syntax nodes to determine whether the next string token to be analyzed matches, in order, the next unmatched anchored node in sequence or any yet-unmatched floating node. Constituent syntax fragment objects 116 are recursively queried, as shown by message 152, to determine whether the leaf nodes within the syntax fragment match the token set 214.

When a syntax keyword is encountered as the next leaf node in sequence during traversal of the syntax fragments, the containing syntax fragment object 116 queries the syntax keyword object 118, as shown by message 154, to determine whether the next unmatched string token matches the keyword. When a syntax parameter is encountered as the next leaf node in sequence during traversal of the syntax fragments, the containing syntax fragment object 116 queries the syntax parameter object 120, as shown by message 158, to determine whether the next unmatched string token matches the parameter.

The syntax parameter object 120 invokes the internal parameter-handler 22 or external parameter-handler 26 (described above) specified by its corresponding syntax description (as exemplified by 106), shown by message 160, in an attempt convert the string token into a valid data object. If the prescribed parameter parser 127, which is either the internal parameter-handler 22 or external parameter-handler 26, successfully converts the string token into a valid data object then resulting valid object is subjected to the restrictions imposed by a constraint parser 122, as shown by message 162. The constraint parser 122 indicates to the parameter parser 127, as shown by message 164, whether the provided data object was valid given the constraints configured via the syntax description for the syntax parameter in the syntax files 20.

The parameter parser 127 (shown by message 166), assuming that it was able to create a data object of the expected type, bases its return indication to the querying syntax fragment on the return status from the constraint parser. If the constraint parser 122 indicates that the data object provided was invalid via message 164, then the parameter parser 127 can indicate to the invoking syntax parameter object 120, as indicated by message 166, that it could not parse the string token. The same indication of failure may be returned should the attempt to convert the token to a data object fail even before the constraints are applied. If the constraint parser 122 indicates that the data object provided was valid via message 164, then the prescribed parameter parser 127 can in turn indicate to the invoking syntax parameter object 120, as shown by message 166, that the token did produce a valid data object. The resulting data object itself is returned to the syntax parameter object 120. The syntax parameter object 120 indicates to the querying syntax fragment object 116, as shown by message 168, whether it matched the string token. If a match occurred, the syntax parameter object 120 adds the resulting data object to the list of objects resulting from successfully converted parameters.

After querying its next contained syntax keyword object 118 or syntax parameter object 120 to determine whether the next unmatched string token can be matched, the action taken by a syntax fragment object 116 depends upon whether the attempt to match the next string token was successful or not as indicated by messages 156 and 168 respectively. If the token matched, then processing of the syntax fragment object 116 continues by attempting to match the next constituent object in the syntax fragment with the next unmatched string token. On the contrary, if there are no more constituent objects within the containing syntax fragment, then the syntax fragment object 116 returns to the parent syntax fragment and attempting to continue the matching process at that level.

As mentioned above, each successive string token that a syntax fragment attempts to match with its leaf nodes is first compared to the next successive unmatched anchored leaf node (determined recursively within nested syntax fragments) and, failing to find a match there, is compared to all unmatched floating leaf nodes. The recursive nature of this matching process within nested syntax fragment objects 116 is represented by message 170. The recursion continues as long as successive string tokens are successfully matched, with the data objects that correspond to successfully parsed parameters accumulating in the list of parameter objects.

At the end of this recursion, the syntax fragment object 116 returns an indication to the querying syntax root object 114, shown by message 172, of whether the syntax fragment (meaning all nodes contained within that syntax fragment) matched the token set 214. As the syntax root object 114 is itself a syntax fragment, this recursion process includes it as well, resulting in an indication to syntax parser 36 of whether the token set 214 matched the syntax root object 114.

The syntax root object 114 indicates to the syntax parser 36 whether the token set 214 matched the corresponding syntax description 42, as shown by message 174. If the root syntax indicates a match, then that means that all anchored syntax nodes within the syntax description were successfully matched in sequence by the token set 214, and that floating syntax nodes within the syntax description may or may not have been matched. When no match occurs, then the syntax parser 36 continues to query its syntax root objects in an attempt to find a match; should it exhaust its list of syntax root objects without detecting a match, then an exception or error code is returned to the main command processor 18 to indicate that no match could be found, and the main command processor 18 may in turn generate a descriptive error message to provide the user with usage and help information regarding the syntax root object and corresponding syntax description which most closely matched the command string 14 corresponding to the token set 214.

In the case of a match, the syntax parser 36 indicates to the main command processor 18, as shown by message 176, that a matching syntax description for the command string 14 corresponding to the token set 214 was found. The main command processor 18 then queries the matching syntax root 114 to obtain the associated action handler function and class or object instance names, as shown by message 178. The syntax root object returns this information, as indicated by message 180. The main command processor 18 then invokes the specific action handler function 33, specified in the syntax root specification 110 using the actionName keyword, as shown by message 182 and as described above in detail. Execution control ultimately returns to the main processor 18 from the action handler 33 as shown by message 184, and the main command processor 18 relinquishes execution control to calling framework 41 as indicated by message 186.

The sequencing of messages and the objects shown here are for purposes of illustration and those skilled in the art can appreciate that the messages, objects, and sequencing of messages are examples and the same are not limiting.

This description of the present invention has been couched in examples and, thus, variations that do not depart from the gist of the present invention are intended to be within the scope of the present invention. Such variations are not to be regarded as a departure from the spirit and scope of the present invention.

1. A code arrangement on a computer readable medium that, when read by a machine, causes the machine to parse a command string resulting in the execution of the commands, the code arrangement comprising:
a command processor code portion for processing at least one command string having a command-name and at least one parameter;
at least one parameter-handler code portion associated with said at least one parameter and adapted for processing said at least one parameter; and
at least one syntax store for storing a plurality of syntax descriptions for a set of said command strings and for storing associations between said parameters and said parameter-handler code portions;
said command processor code portion syntax processing said command string using said syntax descriptions and said parameter-handler code portions.

2. The code arrangement of claim 1 wherein said command processor code portion processing said command string by finding a match between one of said syntax descriptions and said command-string to determine syntactical validity of the said command string and if at least one of said parameter-handler code portions needs to be invoked.

3. The code arrangement of claim 2 wherein said command processor code portion transmitting at least one parameter to said parameter-handler code portion, each of said parameter-handlers returning at least one information unit to said command processor code portion upon successful processing of said at least one parameter.

4. The code arrangement of claim 3 wherein said command processor code portion is operable to invoke a code arrangement designed to receive a list of one or more said information units, said command processor code portion processing said command by passing said information unit received from said parameter-handler to said code arrangement designed to receive said list of one or more information units.

5. The code arrangement of claim 1 wherein said parameters are received as an input to said command processor code portion from a user through a command-line interface.

6. The code arrangement of claim 1 wherein said parameters are received as an input to said command processor code portion from a software module other than said command processor code portion.

7. The code arrangement of claim 1 wherein said syntax store is stored on a computer readable media, said computer readable media being at least one of a magnetic storage medium, a file stored in an electronic memory, a file stored on an optical memory, and a data structure stored in a memory.

8. The code arrangement of claim 1 wherein said command processor further comprises:
a command parser for parsing a plurality of said parameters using said syntax descriptions, said command parser finding a best match between a plurality of parsed parameters with said syntax descriptions sourced from said syntax store.

9. The code arrangement of claim 1 wherein said syntax store is configurable by the user by editing one or more of existing said syntax descriptions and adding newer said syntax descriptions to said syntax store.

10. The code arrangement of claim 1 wherein said parameter-handler returns an indicator for unsuccessful processing of said command-string to said command processor.

11. The code arrangement of claim 1 wherein one or more of said at least parameter-handler code portion is an internal parameter-handler code portion.

12. The code arrangement of claim 1 wherein said command processor allows execution of said command after at least one of a security validation, license validation, and additional screening.

13. The code arrangement of claim 12 wherein said security screening procedure is based upon at least one of a user rights validation, user authentication and security key checking.

14. The code arrangement of claim 12 wherein each said security screening being performed using at least one of said parameters.

15. The code arrangement of claim 1 wherein an operating environment is a JAVA-based object-oriented environment and said command processor and said parameter-handlers are JAVA code portions.

16. The code arrangements of claim 1 wherein said parameter-handler and said internal parameter-handler code portions are parsers.

17. The code arrangement of claim 1 further comprising:
at least one action handler code portion associated with at least one root syntax, said syntax root being one of said syntax descriptions, wherein said action handler code portion being adapted for processing at least one command.

18. An apparatus for executing commands directed to a computer system, the apparatus comprising:
command processing means for processing a received command-string having at least one command name and at least one parameter;
at least one parameter handling means for processing said at least one parameter, said parameter handling means associated with said at least one parameter, said command processing being operatively connected to said at least one parameter handling means; and
a memory to store at least one syntax description for a set of commands;
said command processing means processing and executing said commands using said at least one syntax description and said at least one said parameter handling means.

19. The apparatus of claim 18 wherein said parameter handling means is a plug-in module.

20. The apparatus of claim 18 wherein said command processing means further comprises:
a usage handler for interacting with the user in case of said command string failing to match with any one of said syntax descriptions.

21. The apparatus of claim 18 wherein said usage handler is operable to output a help message about the correct usage of the said syntax description which most closely resembled the said command-string, derived from said means for storing syntax descriptions.

22. The apparatus of claim 18 wherein contents of said memory comprise:
at least one syntax root fragment.

23. The apparatus of claim 22 wherein said syntax fragment comprises:
at least one syntax leaf node selected from a parameter, keyword, and another nested syntax fragment;

24. The apparatus of claim 22 wherein said syntax root fragment comprises:
an action name representing a code portion invoked by said command processing means for processing said command.

25. A method for processing command-strings in an object-oriented environment comprising:
parsing a command-string that includes a command-name and one or more parameters;
retrieving at least one syntax description from a syntax store, said syntax description including references to one or more parameter-handlers;
matching said command-name and said one or more parameters with said at least one syntax description to identify one or more corresponding parameter-handlers; and
processing said one or more parameters using the identified one or more parameter-handlers to produce one or more corresponding information units.

26. The method of claim 25 further comprising:
preparing a list of the one or more information units resulting from the processing step;
calling a code arrangement designed to receive a list of one or more said information units; and
passing said list resulting from the preparing step to said code arrangement.

27. The method of claim 25 further comprising:
outputting an error message where said matching is unsuccessful.

28. The method of claim 27 further comprising:
outputting a help message and a command usage description for a syntax description that most closely matched said command string, said syntax description being sourced from said syntax descriptions.

29. The method of claim 25 further comprising:
applying reflection to determine which of plural action handler code portions to invoke based on successfully matched said syntax descriptions.
